(19) United States
(12) Patent Application Publication
(10) Pub. No.: US 2004/0157974 A1
(43) Pub. Date: Aug. 12, 2004

(54) Printing ink resist composition, method of forming resist film thereof, and method of producing substrate using the same

(75) Inventors: Kouji Takezoe, Hiratsuka-shi (JP); Akito Ichikawa, Hiratsuka-shi (JP); Koichi Tamura, Hiratsuka-shi (JP)

Correspondence Address: SUGHRUE MION, PLLC, 2100 PENNSYLVANIA AVENUE, N.W., SUITE 800, WASHINGTON, DC, 20037, US

(73) Assignee: KANSAI PAINT CO., LTD.

(21) Appl. No.: 10/770,570

(22) Filed: Feb. 4, 2004

(30) Foreign Application Priority Data
Feb. 5, 2003 (JP) 2003-028098

(51) Int. Cl. C08K 3/34; C08K 5/01

(52) U.S. Cl. 524/487; 524/492

(57) ABSTRACT

A printing ink resist composition which contains a phenol resin as the main resin component and further contains a thickening agent; a method of forming a resist film having a desired pattern which comprises conducting a screen printing, by using this resist composition, on the surface of a substrate having a metal layer on its surface; and a method of producing a substrate having a metal layer pattern which further comprises a step of etching the metal layer at portions on which said resist film is not formed and then removing the resist film; are disclosed.

### BACKGROUND OF THE INVENTION

1. Field of the Invention

The present invention relates to a novel printing ink resist composition, a method of forming a resist film thereof, and a method of producing a substrate using the same.

2. Description of the Prior Art

Recently, printing inks are used widely in various fields. Among printing inks, a printing ink resist composition has been developed as one of ink resist materials having a special function in flexo technology.

As concerning such a printing ink resist composition, there is known, for example, a method in which a negative energy ray-sensitive resist composition to be hardened by active energy ray is applied on the surface of a metal substrate such as a coppered laminate substrate, then the composition is irradiated with active energy ray directly or via a printing mask so as to obtain a desired printing pattern, then the un-hardened films are removed by a development treatment, and then the exposed metal layer portions are removed by an etchant to form a desired pattern. Namely, this is a negative pattern formation method (see, Japanese Patent Application Laid-Open (JP-A) No. 2000-63451).

In addition to the above-mentioned method, recently, there is also known a method in which a positive energy ray-sensitive resist composition to be decomposed by active energy ray is applied, then the composition is irradiated with active energy ray, then the films at irradiated portions are removed by a developer, and then the exposed metal layer portions are removed by an etchant to form a desired pattern. Namely, this is a positive pattern formation method (see, JP-A No. 2001-22067).

However, the above-mentioned negative or positive pattern formation methods by active energy ray have problems of necessity of equipments for irradiation of active energy ray and appended equipments, increase in processes due to irradiation with active energy ray, and labor for process management.

Furthermore, there are known as conventional printing inks, for example, printing inks obtained by using rosin-modified phenol resins, rosin ester resins, maleic acid resins, petroleum-based resins or alkyd resins as resin vanish. However, these printing inks are used in offset printing and the like, and even if such printing inks are used as a resist composition, the printed film is totally peeled or partially peeled by etching, consequently, a fine pattern cannot be formed.

### SUMMARY OF THE INVENTION

An object of the present invention is to provide a printing ink resist composition, a method of forming a resist film and a method of producing a substrate using the same, of which process is simple, of which process management is easy and which can form a fine pattern.

The present inventors have intensively studied for attaining the above-mentioned object, and resultantly found that the conventional problems can be wholly solved by further applying a thickening agent into a printing ink resist composition containing a phenol resin as the main resin component, and then completed the present invention.

Namely, the present invention relates to a printing ink resist composition which contains a phenol resin as the main resin component and further contains a thickening agent.

Furthermore, the present invention relates to a method of forming a resist film which comprises a step of conducting a screen printing, by using a printing ink resist composition which contains a phenol resin as the main resin component and further contains a thickening agent, on the surface of a substrate having a metal layer on its surface to form a resist film having a desired pattern.

Furthermore, the present invention relates to a method of producing a substrate having a metal layer pattern which comprises:

(1) a step of conducting a screen printing, by using a printing ink resist composition which contains a phenol resin as the main resin component and further contains a thickening agent, on the surface of a substrate having a metal layer on its surface to form a resist film having a desired pattern,

(2) a step of removing the metal layer at portions on which said resist film is not formed by a development using an etchant, and

(3) a step of removing the resist film after said step (2).

### DETAILED DESCRIPTION OF THE PREFERRED EMBODIMENTS

First, the resist composition of the present invention is described below.

The resist composition of the present invention is characterized in that it comprises a phenol resin as the main resin component and further contains a thickening agent.

As the printing ink resist composition containing a phenol resin as the main resin component, those conventionally used as a printing ink can be used without specific restriction. Concretely, for example, compositions obtained by dissolving or dispersing a phenol resin in an organic solvent (organic solvent-based resist composition) can be used.

As the phenol resin, for example, novolak resins, polyvinylphenol resins are preferably used.

Examples of the novolak resin are resins obtained by poly-condensing at least one of aromatic hydrocarbons such as phenol, m-cresol, o-cresol, p-cresol, 2,5-xylenol, 3,5-xylenol, resorcinol, pyrogallol, bisphenol, bisphenol A, trisphenol, o-ethylphenol, m-ethylphenol, p-ethylphenol, propylphenol, n-butylphenol, t-butylphenol, 1 -naphthol and 2-naphthol in the presence of an acidic catalyst with at least one of aldehydes and ketones selected from aldehydes such as formaldehyde, acetaldehyde, propionaldehyde, benzaldehyde and furfural, and ketones such as acetone, methyl ethyl ketone and methyl isobutyl ketone. Instead of formaldehyde and acetaldehyde, p-formaldehyde and p-aldehyde may be used respectively,

The weight-average molecular weight in terms of polystyrene measured by gel permeation chromatography of the novolak resin is preferably from 300 to 300,000, more preferably from 500 to 200,000 (hereinafter, the gel permeation chromatography is abbreviated as “GPC”, and the weight-average molecular weight measured by GPC is abbreviated as “Mw”). The lower limits of these ranges are significant in the point of etching-resistance, and the upper limits are significant in the point of solubility of a resist film after etching in alkali peeling liquid.

As the aromatic hydrocarbons in the novolak resin, phenol, o-cresol, m-cresol, p-cresol, 2,5-xylenol, 3,5-xylenol and resorcinolare are more preferable among the above-mentioned compounds. It is preferable to use novolak resins obtained by poly-condensing at least one of phenols among them with at least one compound selected from aldehydes such as formaldehyde, acetaldehyde and propionaldehyde. Among the aldehydes, formaldehyde is more preferable.

Examples of the polyvinylphenol resin are polymers obtained from one or more of o-hydroxystyrene, m-hydroxystyrene, p-hydroxystyrene, 2-(o-hydroxy-phenyl)propylene, 2-(m-hydroxyphenyl)propylene, 2-(p-hydroxyphenyl)propylene. The hydroxystyrenes may have substituents such as halogen atoms (e.g., chlorine, bromine, iodine and fluorine) and C₁ to C₄ alkyl substituents on its aromatic ring. Therefore, the polyvinylphenol resin may have halogen atoms or C₁ to C₄ alkyl substituents on its aromatic ring. However, an unsubstituted polyvinylphenol resin is preferable.

The polyvinylphenol resin is usually obtained by polymerizing one or more hydroxystyrenes optionally having a substituent in the presence of a radical polymerization initiator or cation polymerization initiator. This polyvinylphenol resin may be partially hydrogenated. Furthermore, some OH groups on polyvinlylphenols may be protected with a t-butoxycarbonyl group, pyranyl group, franyl group and the like.

The Mw of the polyvinylphenol resin is preferably from 1,000 to 100,000, more preferably from 1,500 to 50,000. The lower limits of these ranges are significant in the point of etching-resistance, and the upper limits are significant in the point of solubility of a resist film after etching in alkaline peeling solution.

The novolak resins and polyvinylphenol resins as described above can be obtained as commercially available articles. The trade names are, for example, MER-7966, MER-7969, MER-7971 and MER7980 (all are manufactured by Meiwa Kasei K. K.); and PR-HF-3 and PR-50731 (all are manufactured by Sumitomo Bakelite Co., Ltd.).

In the present invention, when compositions obtained by dissolving or dispersing a phenol resin in an organic solvent are used, the organic solvent is not particularly restricted providing it is a solvent capable of dissolving or dispersing a phenol resin, and conventionally known solvents can be used. Specific examples of the organic solvent include hydrocarbon-based solvents such as hexane, heptane, octane, toluene, xylene, dichloromethane, chloroform, carbon tetrachloride and trichloroethylene; alcohol-based solvents such as methanol, ethanol, propanol and butanol; ether-based solvents such as diethyl ether, dipropyl ether, dibutyl ether, ethyl vinyl ether, dioxane, propylene oxide, tetrahydrofuran, cellosolve, methyl cellosolve, butyl cellosolve, methyl carbitol and diethylene glycol monoethl ether; ketone-based solvents such as acetone, methyl ethyl ketone, methyl isobutyl ketone, isophorone and cyclohexanone; ester-based solvents such as methyl acetate, ethyl acetate, propyl acetate and butyl acetate; and other solvents such as pyridine, formamide and N,N-dimethylformamide.

In the present invention, a thickening agent is further compounded in a composition, as described above, which contains a phenol resin as the main resin component. Specifically, it is preferable to use an inorganic fine particles or a wax as the thickening agent.

The average particle size of the inorganic fine particle is preferably from 3 nm to 10 μm, more preferably from 5 nm to 8 μm. The lower limits of the above-mentioned ranges are significant in the point of suppressing the viscosity of a composition low so as to prevent a formation of non-applied portions to improve printing workability. The upper limits of the above-mentioned ranges are significant in the point of improving the smoothness and linearity of the pattern surface or side face to obtain a fine pattern.

The shape of the inorganic fine particle may be any of sphere, scale, plate and amorphous. Particularly, inorganic fine particles in the form of scale or sphere are preferable because they can cause the specific viscosity as described in detail later.

The inorganic fine particles can be obtained as commercially available articles. Trade names of preferable inorganic fine particles are listed below. The trade names of spherical fine powder silica include SILOSPHERE C-1504 (average particle size: 4.5 μm) (manufactured by Fuji Silicia Chemical K.K.). Trade names of spherical silicon oxide include ADMAFINE SO-25R (average particle size: 800 nm) (manufactured by ADMATECK K.K.), AEROSIL 200 (average particle size: 12 nm), AEROSIL 380 (average particle size: 7 nm), AEROSIL R805 (average particle size: 12 nm) and AEROSIL R812 (average particle size: 7 nm) (all are manufactured by Nippon Aerosil K.K.). Trade names of spherical acrylic fine particle include GANZ PEARL GM-0401A (average particle size: 4 μm), spherical PBMA-based cross-linked fine particle GANZ PEARL GB-05S (average particle size: 5 μm) (all are manufactured by GANZ Kasei K.K.), spherical resin fine particle TRARY FIL E-500 (average particle size: 3 μm) (manufactured by Toray Dow Corning Silicone K.K.), barium sulfate BF-10 P (average particle size: 60 nm), barium sulfate BF-20P (average particle size: 30 nm), barium sulfate BF-20F (average particle size: 30 nm) (all are manufactured by Sakai Chemical Industry K.K.), scale-shaped micro mica MK-100 (average particle size: 3 to 5 μm), organic-treated mica SOMASIF ME-100 (average particle size: 5 to 7 μm) (all are manufactured by Corp Chemical K.K.).

As the wax, for example, amide compounds having 12 to 44 carbon atoms and bisamide compounds having 12 to 44 carbon atoms are preferable.

Specific examples of the amide compounds having 12 to 44 carbon atoms include lauric amide, palmitic amide, stearic amide, behenic amide, hydroxystearic amide, erucic amide, ricinolic amide, N-stearylstearic amide, N-oleyloleic amide, N-stearic oleic amide, N-stearylerucic amide, N-oleylpalmitic amide, methylolstearic amide.

Specific examples of the bisamide compounds having 12 to 44 carbon atoms include methylenebisstearic amide, ethylenebisstearic amide, ethylenebisbehenic amide, hexamethylene bisstearic amide, hexamethylenebisbehenic amide, N,N′-distearyladipic amide, N-N′-distearylsevacic amide, N,N′-methylenebisoctadecaneamide, ethylenebisoleic amide, hexamethylenebisoleic amide, N,N′-dioleyladipic amide, N,N′-dioleylsevacic amide, m-xylylenebisstearic amide, N,N′-distearylisophthalic amide.

Such waxes can be obtained as commercially available articles. The trade names include DISPERON 6940-10X (fatty amide wax), DISPERON 6900-20X (fatty amide wax) and DISPERON A650-20X (fatty amide wax) (all are manufactured by Kusumoto Kasei K.K.).

The compounding ratio of the thickening agent is preferably from 10 to 500 parts by weight, more preferably from 20 to 300 parts by weight based on 100 parts by weight of resin solid content. The lower limits of the above-mentioned ranges are significant in the point of obtaining desired viscosity and viscose characteristics to improve printing workability. The upper limits of the above-mentioned ranges are significant in the point of securing sufficiently the resin amount in a resist film to improve etching-resistance.

In the printing ink resist composition, conventionally known additives can be compounded, if necessary. Specifically, dyes, pigments, other fillers than the above-mentioned examples, antioxidants, repelling preventing agents, other resins than the above-mentioned examples, plasticizers, thickening agents can be used.

The solid content of the printing ink resist composition is preferably from 20 to 90 wt %, more preferably from 30 to 70 wt %. The lower limits of the above-mentioned ranges are significant in the point of suppressing the amount of a solvent to prevent seepage from a resist film. The upper limits of the above-mentioned ranges are significant in the point of suppressing suitably the drying speed of resist solution to prevent early drying of a plate to improve printing workability.

The viscosity of the printing ink resist composition measured by a rotary viscometer (6 rpm, measuring temperature: 25° C.) is preferably from 1 to 300 Pa.s, more preferably from 2 to 200 Pa.s. The lower limits of the above-mentioned ranges are significant in the point of suppressing flowing of a printed resist pattern to improve pattern precision. The upper limits of the above-mentioned ranges are significant in the point of imparting flowability to resist solution for application of sufficient resist solution on a substrate.

The viscosity index of the printing ink resist composition is preferably 1.0 or more, and more preferably from 1.1 to 10.0. The lower limits of the above-mentioned ranges are significant in the point of decreasing suitably the viscosity of resist solution in printing for application of sufficient resist solution on a substrate. This viscosity index is specifically structural viscosity index R defined by the following formula (1):

R=Va/Vb (1)

wherein the formula (1), Va represents apparent viscosity (mPa.sec) measured by MR300 rheometer (trade name, manufactured by Rheology K.K.) at a temperature of 20° C. at a revolution of 6/min., and Vb represents viscosity (mPa.sec) measured by the same manner at a revolution of 60/min.

The printing ink resist composition of the present invention can be applied to any printing plates such as latter press, gravure and screen. Particularly, it is preferable to use the composition in screen printing.

The method of forming a resist film according to the present invention is characterized in that it comprises a step of conducting a screen printing, by using a printing ink resist composition of the present invention, on the surface of a substrate having a metal layer on its surface to form a resist film having a desired pattern.

Examples of the substrate having a metal layer on its surface are preferably laminate substrates obtained by applying a conductive metal such as copper, gold, silver, aluminum and chromium on a glass substrate or a resin surface substrate by, for example, lamination or vapor-deposition. The resin surface substrate may be made of a phenol resin, epoxy resin, polyamide resin, or these resins reinforced by glass fiber. The substrates and metal layers may be composed of one layer or a plurality of layers. The substrate may have a penetration or non-penetration through hole.

It is preferable for the viscosity, solid content and viscosity index of the resist composition, which is used for print, to satisfy the above-mentioned conditions.

After conducting a screen printing, if necessary, a drying step of the printed resist composition is conducted. The drying conditions may be determined appropriately depending on the kind of an organic solvent used, and usually, drying is conducted at 20° C. for 1 to 30 minutes. When drying at temperatures of around 80° C., the drying time may be form 10 seconds to 10 minutes.

The method of producing a substrate having a metal layer pattern is characterized in that it comprises the following steps:

(1) a step of conducting a screen printing, by using a printing ink resist composition which contains a phenol resin as the main resin component and further contains a thickening agent, on the surface of a substrate having a metal layer on its surface to form a resist film having a desired pattern,

(2) a step of removing the metal layer at portions on which said resist film is not formed by a development using an etchant, and

(3) a step of removing the resist film after said step (2).

The step (1) is as described above.

In the step (2), examples of the etchant include aqueous solutions of ferric chloride, cupric chloride, or a mixed acid of nitric acid, acetic acid and phosphoric acid. The etching method is conducted by, for example, etching at 40° C. for about 5 minutes by dipping and spraying.

In the step (3), for example, solvents dissolving or dispersing a phenol resin can be used for removing the resist film.

In the present invention, remarkable effects can be obtained as described below.

(a) A phenol resin used as a resist resin component has excellent solubility in an organic solvent, and as a result, it can be realized to obtain a viscosity and viscose characteristics suitable for printing resist compositions.

(b) A phenol resin film after evaporation of an organic solvent shows excellent chemical resistance against the etchant, and as a result, it can be realized to form a fine pattern.

(c) By combining a thickening agent with a phenol resin with, it can be realized to obtain a viscosity and viscose characteristics suitable for printing resist compositions.

(d) Thickening agents such as inorganic fine particles and waxes are excellent in chemical resistance against the etchant, and as a result, it can be realized to form a fine pattern.

The following examples are further illustrate the present invention in more detail, but do not limit the scope of the present invention. In examples and comparative examples, “parts” and “%” represent “parts by weight” and “% by weight” respectively.

### PRODUCTION OF PHENOL RESINS USED IN EXAMPLES 1 TO 4 AND COMPARATIVE EXAMPLE 1

Into 5 L four-necked flask equipped with a stirrer, thermometer and heat exchanger, 750 parts by weight of m-cresol, 500 parts of p-cresol (P1=1250 parts), 938.4 parts of 37% formalin (A) (molar ratio A/P1=1.0) and 62.5 parts of triethylamine were added, and they reacted at pH of 8.5 and a reaction temperature of from 68 to 72° C. for 4 hours (primary reaction). The proportion of components containing three or more nuclei in completion of the primary reaction was 55%. Thereafter, 350 parts of 10% oxalic acid water was added for neutralization (pH=5.2), and then 175 parts of m-cresol, 1237.5 parts of p-cresol (P2=1412.5 parts; molar ratio A/(P1+P2)=0.47, P1/P2=0.88) and 38.5 parts of oxalic acid were added, and then they reacted at pH of 2.0 and a reaction temperature of from 98 to 102° C. for 4 hours (secondary reaction). After completion of the secondary reaction, the solution was cooled down to 70° C., and then 125 parts of acetone and 1250 parts of ion exchange water were added and stirred at about 70° C. and then leaved standing. After removal of separated water, water-washing operation was conducted again using 125 parts of acetone and 1250 parts of ion exchange water. Then, removal of water was conducted under atmospheric pressure up to an inner temperature of 160° C., further, removal of water and monomers was conducted under a reduced pressure of 60 torr up to a temperature of 195° C. to obtain 1300 parts of a phenol resin. The resulted resin had a weigh-average molecular weight of 11,000.

### PRODUCTION OF ACRYLIC RESIN USED IN COMPARATIVE EXAMPLE 2

A mixture composed of 40 parts of methyl methacrylate, 40 parts of butyl acrylate, 15 parts of styrene, 5 parts of acrylic acid and 2 parts of azobisisobutyronitrile was added dropwise under a nitrogen gas atmosphere into 90 parts of propylene glycol monomethyl ether kept at 110° C. over 3 hours. After complete of addition, the mixture was aged for 1 hour, and then a mixture composed of 1 part of azobisdimethylvaleronitrile and 10 parts of propylene glycol monomethyl ether was added dropwise therein over 1 hour, and the resulted mixture was further aged for 5 hours to obtain a acrylic resin solution.

### EXAMPLE 1

The phenol resin produced as described above was dissolved in cyclo-hexanone so that the solid content was 50%, and spherical silicon oxide (fine powder silica, manufactured by Nippon Aerosil K.K., trade name: AEROSIL R812, average particle size: 7 nm) as a thickening agent was added in a proportion of 50 parts based on 100 parts of resin solid content, and the resulted mixture was dispersed by triple rolls, to obtain screen printing resist solution.

This resist solution was subjected to 500 mesh screen printing to form line/space=100/100 μm pattern on a copper substrate vapor-deposited on glass, and heated at 100° C. for 30 minutes by a hot plate. Then, the etching step thereof was conducted by dipping it into 4% ferric chloride aqueous solution in it was subjected.

### EXAMPLES 2 TO 4 AND COMPARATIVE EXAMPLES 1 AND 2

Resist solutions were prepared and the etching step was conducted in the same manner as in Example 1 except that compositions shown in Table 1 were applied.

The test results of Examples and Comparative Examples are shown in the following Table 1.

TABLE 1

| | | | | | Comparative | |
|---|---|---|---|---|---|---|
| | Example | | | | Example | |
| | 1 | 2 | 3 | 4 | 1 | 2 |
| Phenol resin (part) | 100 | 100 | 100 | 100 | 100 | |
| Acrylic resin (part) | | | | | | 100 |
| Kind of thickening agent | a | a | b | c | | a |
| Compounding amount of | 30 | 70 | 10 | 50/10 | | 30 |
| thickening agent (part) | | | | | | |
| Viscosity (Pa · s) | 10 | 80 | 20 | 110 | 0.5 | 120 |
| Pattern formation | ◯ | ◯ | ◯ | ◯ | X | ◯ |
| Etching resistance | ◯ | ◯ | ◯ | ◯ | ◯ | X |

Thickening agent a: Spherical silicon oxide (manufactured by Nippon Aerosil K.K., trade name: AEROSIL R812, average particle size: 7 nm)
Thickening agent b: Fatty amide wax (manufactured by Kusumoto Kasei K.K., trade name: DISPERON 6900)
Thickening agent c: Barium sulfate (manufactured by Sakai Chemical Industry K.K., trade name: Barium sulfate BF-20P, average particle size: 30 nm)/fatty amide wax (manufactured by Kusumoto Kasei K.K., trade name: DISPERON 6900)
Viscosity: B type viscometer: 6 rpm, at 25° C.
Pattern formation: ◯: Line was formed within 100 ± 5 μm. X: Line was not formed within 100 ± 5 μm.
Etching resistance: ◯: Resist film was not peeled. X: Resist film was peeled.

1. A printing ink resist composition which contains a phenol resin as the main resin component and further contains a thickening agent.

2. The printing ink resist composition according to claim 1 wherein the phenol resin is one or both of a novolak resin and a polyvinylphenol resin.

3. The printing ink resist composition according to claim 1 wherein the thickening agent is an inorganic fine particle having a particle size of 3 nm to 10 μm.

4. The printing ink resist composition according to claim 1 wherein the thickening agent is a wax.

5. The printing ink resist composition according to claim 1 wherein the content of the thickening agent is from 10 to 500 parts by weight based on 100 parts by weight of resin solid content.

6. The printing ink resist composition according to claim 1 which is an organic solvent-based resist composition.

7. The printing ink resist composition according to claim 1 wherein the viscosity measured by a rotary viscometer (6 rpm, measuring temperature 25° C.) is from 1 to 300 Pa.s.

8. The printing ink resist composition according to claim 1 which is a screen printing ink resist composition.

9. A method of forming a resist film which comprises a step of conducting a screen printing, by using a printing ink resist composition which contains a phenol resin as the main resin component and further contains a thickening agent, on the surface of a substrate having a metal layer on its surface to form a resist film having a desired pattern.

10. A method of producing a substrate having a metal layer pattern which comprises:
(1) a step of conducting a screen printing, by using a printing ink resist composition which contains a phenol resin as the main resin component and further contains a thickening agent, on the surface of a substrate having a metal layer on its surface to form a resist film having a desired pattern,
(2) a step of removing the metal layer at portions on which said resist film is not formed by a development using an etchant, and
(3) a step of removing the resist film after said step (2).
